(19) United States
(12) Patent Application Publication
(10) Pub. No.: US 2020/0260702 A1
(43) Pub. Date: Aug. 20, 2020

(54) SUBMERSIBLE FISHING DEVICE FOR FISHING

(71) Applicant: FAHAD ABDULLA ALBURSHAID, Alwakra (QA)

(72) Inventor: FAHAD ABDULLA ALBURSHAID, Alwakra (QA)

(21) Appl. No.: 16/861,431

(22) Filed: Apr. 29, 2020

(51) Int. Cl. A01K 81/06; B63G 8/00

(52) U.S. Cl. CPC A01K 81/06; B63G 2008/005; B63G 8/001

(57) ABSTRACT

The present invention discloses a remote-controlled fishing device for catching fish. The fishing device may be controlled by a remote-controlled device for catching the fish. The fishing device is provided with standard and night vision cameras. A fisherman can view and target a desired fish based on images and videos captured by the cameras of the fishing device. For targeting or catching fish under the water, the fishing device is further integrated with one or more fishing arrows or spears. Various operations of the cameras or fishing arrows or spears may be controlled by operating one or more dedicated buttons or switches provided with the remote-controlled device. The remote-controlled fishing device disclosed in the present invention is sturdy, portable, and eco-friendly and increases interests of the fisherman in fishing.

### FIELD OF THE INVENTION

The present application generally relates to a fishing equipment, and more particularly to a submersible fishing device for fishing. More specifically, the present invention relates to a remote-controlled fishing device for catching fish under water. The fishing device may be controlled by a remote-controlled device for catching fish under water.

### BACKGROUND

In general, fishing is performed by a fisherman by using a lure or baited hook or by using a net or trap. The fisherman may perform fishing from the shore of a lake or river or may perform fishing from a boat. During the boat fishing, the boat may be stationary or moving while the lure or bait is trolled behind the boat. Common experienced problems are that the fisherman has limited control over the positioning of the lure under the water. For depth control, a float may be positioned on the fishing line at a distance from the lure equal to the desired depth. However, this method is not accurate when the lure is moving through the water.

Many-a-times, the fisherman may use hook lines or may use a net or trap for fishing. Outriggers or downriggers may be utilized by the fisherman to deploy the hook lines. Outriggers and downriggers utilize an underwater foil connected to the lines, and the speed generated by the trawler causes the foil to pull the hook lines outward from the side of the trawler, or to pull the lines to a desired depth, respectively. The use of outriggers and downriggers requires that the trawler maintain sufficient headway to provide the necessary force on the foils to properly deploy the lines. In an alternative method, the trawler may let out a length of net behind the trawler using electric wenches, and the trawler may then steam in a circle to enclose a school of fish with the net. This method of deploying a net also requires that the trawler maintain sufficient headway to avoid tangling the net.

In general, when fishing, the fisherman manually casts the fishing hook or the net away from the shore and then proceeds fishing. Since the distance of manual casting is limited, it is difficult to achieve the goal of catching fish effectively. In addition, the effects of bad weather patterns and terrible bank conditions usually make the fisherman unsatisfied with their fishing activities so that the fishing sport can never become a popular leisure activity.

In light of the above-mentioned background, there is a need for a technical solution that solves the above-mentioned problems and provides a seamless mechanism for fishing. Thus, what is needed is an automated fishing device that can be steered under the water by a remote-control device or by preprogrammed instructions or any combination thereof.

### SUMMARY

It will be understood that this disclosure is not limited to the particular systems, apparatus, and methods described herein, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

It is an objective of the present invention to provide a submersible fishing device for fishing. The fishing device looks very similar to a real fish, and hence is very efficient and effective in catching fish under the water.

It is another objective of the present invention to provide a remote-controlled fishing device for catching fish under water. The fishing device may be controlled by a remote-controlled device for catching fish under the water. The fishing device can reach deeper fishing points under a water body such as a river, lake, or sea. The fishing device is easy to use for all ages and no experience is required. The fishing device facilitates an ability to see under the water and target fish under the water as per the preferences of a fisherman who is operating the remote-controlled device. Thus, the fishing device in conjunction with the remote-controlled device makes it easier for the fisherman to catch fish under the water.

It is another objective of the present invention to provide the remote-controlled fishing device with standard and night vision cameras. These cameras are installed at various positions or points of the fishing device and are useful in viewing under the water that is beneficial during the fishing activities. The fisherman can view and target a desired fish based on the images and videos captured by the cameras of the fishing device. For targeting or catching fish under the water, the fishing device is further integrated with one or more fishing arrows or spears that are located inside a body of the fishing device. Various operations of the cameras or fishing arrows or spears may be controlled by operating one or more dedicated buttons or switches provided with the remote-controlled device. The remote-controlled fishing device disclosed in the present invention is sturdy, portable, and eco-friendly and increases interests of the fisherman in fishing.

Further, the present invention relates to a transmitter together with appropriate software or programming instructions which are configured in the form of the remote-controlled device with a display screen for use with the submersible fish shaped fishing device with the cameras. The transmitter may use a conventional radio frequency link to transmit commands or signals or instructions to the radio-controlled submersible fishing device. The remote-controlled device (such as a tablet remote control device) provides a display and functionalities to control the submersible fishing device.

It is the general object of the present invention to provide a remote control and submersible unit for improving the fishing experience and improved yield. The remote control enables an operator (i.e., the fisherman) to simulate the maneuvers of a fish with the ability to navigate through water and release and return an arrow to catch fish under the water.

These and other features and advantages of the present invention will become apparent from the detailed description below, in light of the accompanying drawings.

### BRIEF DESCRIPTION OF ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a communication environment between a fishing device and a remote-controlled device, according to an exemplary embodiment of the present invention;

FIG. 2 is a diagram that illustrates a front-side view of the fishing device, according to an exemplary embodiment of the present invention;

FIG. 3 is a diagram that illustrates a rear view of the fishing device, according to an exemplary embodiment of the present invention;

FIG. 4 is a diagram that illustrates a rear-side view of the fishing device, according to an exemplary embodiment of the present invention;

FIG. 5 illustrates a front view of the remote-controlled device, according to an exemplary embodiment of the present invention;

FIG. 6 illustrates a rear view of the remote-controlled device, according to an exemplary embodiment of the present invention;

FIG. 7 is a block diagram that illustrates internal components of the fishing device, according to an exemplary embodiment of the present invention; and

FIG. 8 is a diagram that illustrates a system architecture of a computer system for facilitating under water fishing, according to an exemplary embodiment of the present invention.

Further areas of applicability of the present invention will become apparent from the detailed description provided hereinafter. It should be further understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes a submersible fishing device that facilitates catching of one or more fishes under the water. The fishing device may be controlled by a remote-controlled device for catching one or more fishes. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the present invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Unless stated otherwise, terms such as “first” and “second” are used to arbitrarily distinguish between the elements or entities. Thus, these terms are not necessarily intended to indicate temporal or other prioritization of such elements or priorities. While various exemplary embodiments of the disclosed systems, apparatuses, and methods have been described below, it should be understood that they have been presented for purposes of example only, and not limitations. It is not exhaustive and does not limit the present invention to the precise form disclosed. Modifications and variations are possible in light of the below teachings or may be acquired from practicing of the present invention, without departing from the breadth or scope.

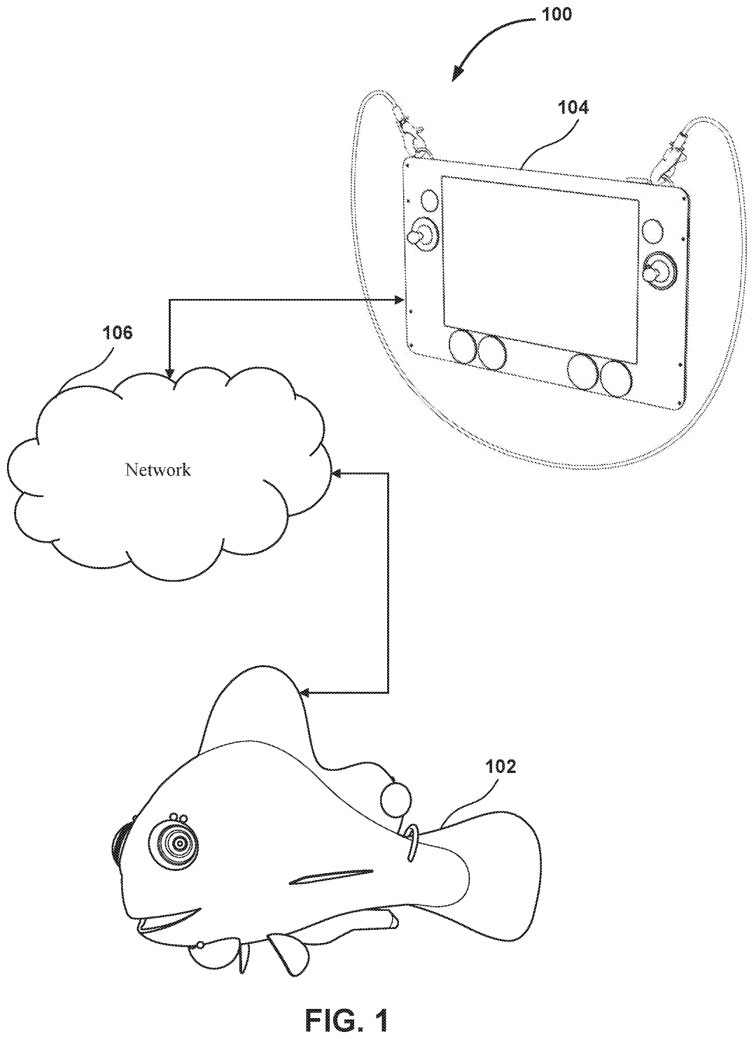

The fishing device of the present invention will now be described with reference to the accompanying drawings, which should be regarded as merely illustrative without restricting the scope and ambit of the present invention. Embodiments of the present invention will now be described with reference to FIGS. 1-8.

FIG. 1 is a diagram that illustrates a communication environment 100 between a fishing device 102 and a remote-controlled device 104, according to an exemplary embodiment of the present invention. The fishing device 102 and the remote-controlled device 104 communicate with each other via a communication network such as a network 106.

The fishing device 102 may be a fish-shaped like fishing unit and may include suitable logic, circuitry, interfaces, and/or code, executable by the circuitry, that may be configured to perform one or more operations associated with under water fishing. The fishing device 102 may include an inboard jet that propels the fishing device 102 under the water, using a controller. The remote-controlled device 104 may be a computing device and may include suitable logic, circuitry, interfaces, and/or code, executable by the circuitry, that may be configured to perform one or more operations associated with controlling the fishing device 102. The remote-controlled device 104 may be a computing device or application, which may include a software framework, that may be configured to create the application implementation and perform the various dedicated operations. The remote-controlled device 104 may be realized through various web-based technologies, such as, but are not limited to, a Java web-framework, a .NET framework, a professional hypertext preprocessor (PHP) framework, a python framework, or any other web-application framework. The remote-controlled device 104 may also be realized as a machine-learning model that implements any suitable machine-learning techniques, statistical techniques, or probabilistic techniques. Examples of such techniques may include expert systems, fuzzy logic, support vector machines (SVM), Hidden Markov models (HMMs), greedy search algorithms, rule-based systems, Bayesian models (e.g., Bayesian networks), neural networks, decision tree learning methods, other non-linear training techniques, data fusion, utility-based analytical systems, or the like. Examples of the remote-controlled device 104 may include, but are not limited to, a personal computer, a laptop, or a network of computer systems. The remote-controlled device 104 may be remotely connected to a database server. The database server includes suitable logic, circuitry, interfaces, and/or code, executable by the circuitry, that may be configured to perform one or more operations, such as receiving, storing, processing, and transmitting queries, data, or content. The database server may be a data management and storage computing device that is communicatively coupled to the remote-controlled device 104 via the one or more communication networks to perform the one or more fishing operations. Examples of the database server may include, but are not limited to, a personal computer, a laptop, or a network of computer systems.

In the context of the present invention, the fishing device 102 refers to an electronic fish-shaped like device that can be used to communicate with other devices or servers over one or more communication networks such as the communication network 106. Various devices in the communication environment 100 may be capable of connecting to the Internet. It should be noted that the term “Internet” is intended to encompass similar systems as well (i.e., World Wide Web or “www”) comprising the capability to communicate and access information through the communication network 106. Examples of types of the communication network 106 may include, but are not limited to, a local area network, a wide area network, a radio network, a virtual private network, an internet area network, a metropolitan area network, a satellite network, Wi-Fi, Bluetooth Low energy, a wireless network, and a telecommunication network. Examples of the telecommunication network may include, but are not be limited to, a global system for mobile communication (GSM) network, a general packet radio service (GPRS) network, third Generation Partnership Project (3GPP), an enhanced data GSM environment (EDGE), and a Universal Mobile Telecommunications System (UMTS). The present invention should not be limited in its communication nomenclature.

In operation, an operator (such as a fisherman) submerges the fishing device 102 in a water body such as a lake, river, or sea. The operator further uses the remote-controlled device 104 to control the fishing device 102 under the water. For example, the operator uses the remote-controlled device 104 to turn ON the fishing device 102 under the water. The operator further uses the remote-controlled device 104 to navigate the fishing device 102 at different depths under the water. The operator further uses the remote-controlled device 104 to turn ON one or more camera devices of the fishing device 102 in order to view the underwater scenery (i.e., fishing environment) on a display screen of the remote-controlled device 104. The operator further uses the remote-controlled device 104 to control speed of the fishing device 102. The operator further uses the remote-controlled device 104 to control the maneuver or directions of the fishing device 102 under the water. The operator further uses the remote-controlled device 104 to control one or more types of light associated with the fishing device 102. Such lights may help the operator to capture good quality images and videos of the underwater scenery, which in turn helps the operator to locate an underwater fish and aim the targeted underwater fish with much ease. The operator may use the remote-controlled device 104 to view, locate, and target the underwater fish by using one or more fishing arrows or spears. The fishing arrows or spears are located inside a body of the fishing device 102 and can be released from the body of the fishing device 102 or returned back into the body of the fishing device 102 as per the operator's action and preferences. The fishing arrows or spears may be released through a mouth of the fishing device 102 to catch the underwater targeted fish. Based on successful or unsuccessful action, the operator may use the remote-controlled device 104 to get back the released fishing arrows or spears. Once the fish has been caught by the fishing arrows or spears, the operator may use the remote-controlled device 104 to navigate the fishing device 102 and bring it out of the water to get the caught fish. In some exemplary embodiments, the fishing device 102 may include a fish container that can be used for storing the caught fish. With the fish container, the operator may catch multiple fishes at the same time with ease without diving-in or diving-out the fishing device 102 multiple times.

In an embodiment, various commands, signals, or instructions associated with the one or more fishing operations, as described above, are communicated between the fishing device 102 and the remote-controlled device 104 via the communication network 106. The present invention relates to a transmitter together with appropriate software or programming instructions which are configured in the form of the remote-controlled device 104 with the display screen for use with the submersible fish shaped fishing device 102 with the cameras. The transmitter may use a conventional radio frequency link to transmit commands or signals or instructions to the radio-controlled submersible fishing device 102. The remote-controlled device 104 (such as a tablet remote control device) provides a display and functionalities to control the submersible fishing device 102. Thus, it is the general object of the present invention to provide a remote control and submersible unit for improving the fishing experience and improved yield. The remote control enables the operator (i.e., the fisherman) to simulate the maneuvers of a fish with the ability to navigate through water and release and return the fishing arrows or spears to catch the underwater targeted fish.

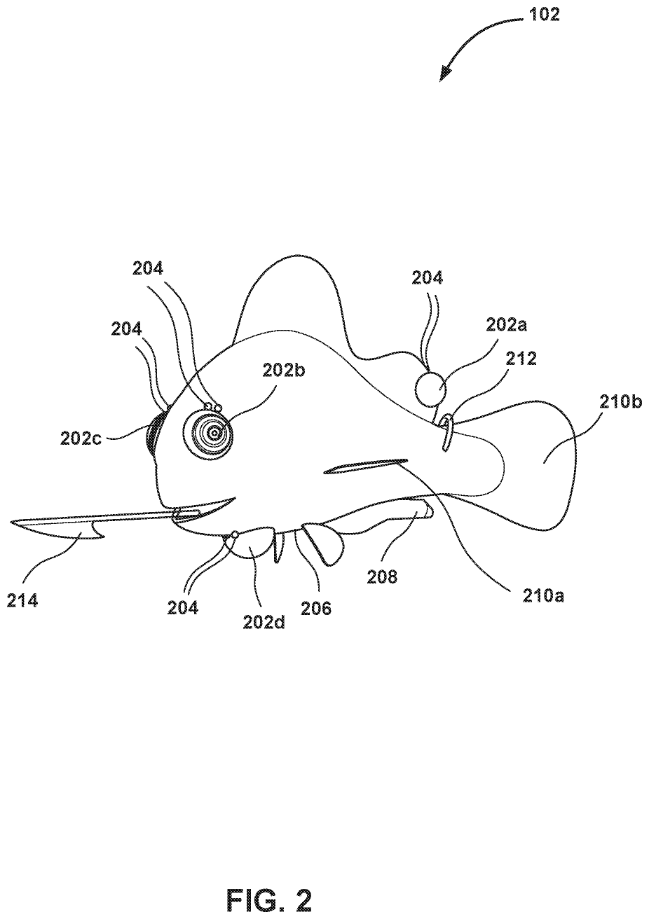

FIG. 2 is a diagram that illustrates a front-side view of the fishing device 102, according to an exemplary embodiment of the present invention. The fishing device 102 includes camera devices 202a-202d. Each camera device is installed on one or more body parts of the fishing device 102. For example, the camera devices 202b and 202c are installed as two eyes of the fishing device 102. Another camera device 202a is installed just before a tail of the fishing device 102. Another camera device 202d is installed just below a mouth of the fishing device 102, around a neck of the fishing device 102. Similarly, if required, other camera devices may be installed on or along other body parts of the fishing device 102. Each camera device acts as an eye of the fishing device 102 and is configured to capture images and videos of associated underwater scenery when the fishing device 102 is submerged under the water. Various images and videos captured by the camera devices 202a-202d may be streamed on the display of the remote-controlled device 104 via the communication network 106. Further, one or more types of lights 204 (such as standard light and night vision light) may be installed over each camera device such as the camera devices 202a-202d. These lights assist the camera devices 202a-202d to capture good quality images and videos of the associated underwater scenery including one or more fishes.

In an embodiment, the fishing device 102 further includes a waterproof USB charging port 206 for charging a battery kit including one or more batteries of the fishing device 102. The waterproof USB charging port 206 may be used for charging the battery kit as per the charging requirement of the one or more batteries. The one or more batteries fulfill power supply requirements of the fishing device 102 during its operation under the water. The one or more batteries may be integrated inside the body of the fishing device 102. All internal components of the fishing device 102 that require power supply for their operations are electrically connected to the one or more batteries of the fishing device 102. All electrical connections are insulated by using an appropriate insulating material to avoid short-circuiting during their operations.

In an embodiment, the fishing device 102 further includes an inboard jet engine 208 that facilitates propelling of the fishing device 102 under the water. The fishing device 102 further includes side fins 210a that are used for steering the fishing device 102 under the water. The side fins 210a are capable of moving up and down as per the navigation instruction or signals or commands provided by the operator by using the remote-controlled device 104. The fishing device 102 further includes a tail fin 210b that is used a rudder for steering the fishing device 102 under the water. The tail fin 210b is capable of moving side to side as per the navigation instruction or signals or commands provided by the operator by using the remote-controlled device 104. The fishing device 102 further includes a retractor loop 212 that is located just before a tail of the fishing device 102. A fishing line or string may be attached to the retractor loop 212 and leads to a fishing pole located near a shore of the water body. This allows the operator to tie the fishing line, for the ability to reel in the catch. The fishing device 102 further includes one or more sets of fishing arrows or spears 214 that are placed inside the body of the fishing device 102. The fishing arrow or spear 214 may be configured to be released from the body via the mouth of the fishing device 102 or get back the released arrow or spear 214 via the mouth into the body of the fishing device 102. Releasing or retracing back of the fishing arrow or spear 214 is controlled as per the instruction or signals or commands provided by the operator by using the remote-controlled device 104. For example, when a fisherman locates an underwater fish (that is along a target line) based on the images and videos displayed on the display of the remote-controlled device 104, the fisherman may utilize the remote-controlled device 104 to provide an input to release the fishing arrow or spear 214 to catch the fish. Such input may be a touch-based input, a voice-based input, a toggle-based input, a gesture-based input, or any combination thereof. When the fishing arrow or spear 214 is aimed correctly, the fishing arrow or spear 214 hits the fish and catches it. Thereafter, the fisherman may use the fishing line tied with the retractor loop 212 to retract the fishing device 102 and remove the caught fish.

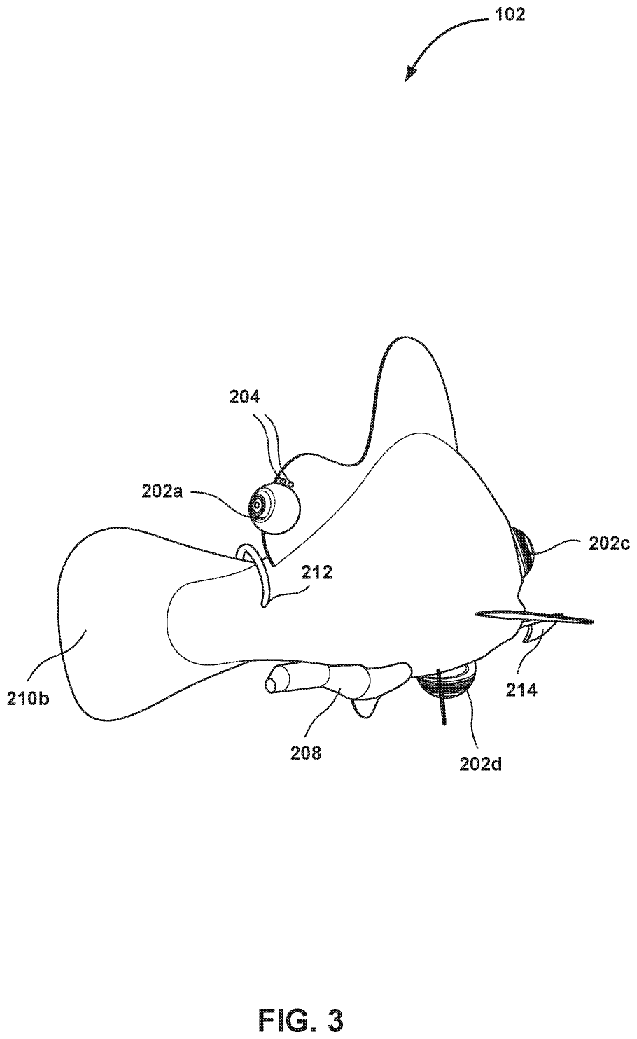

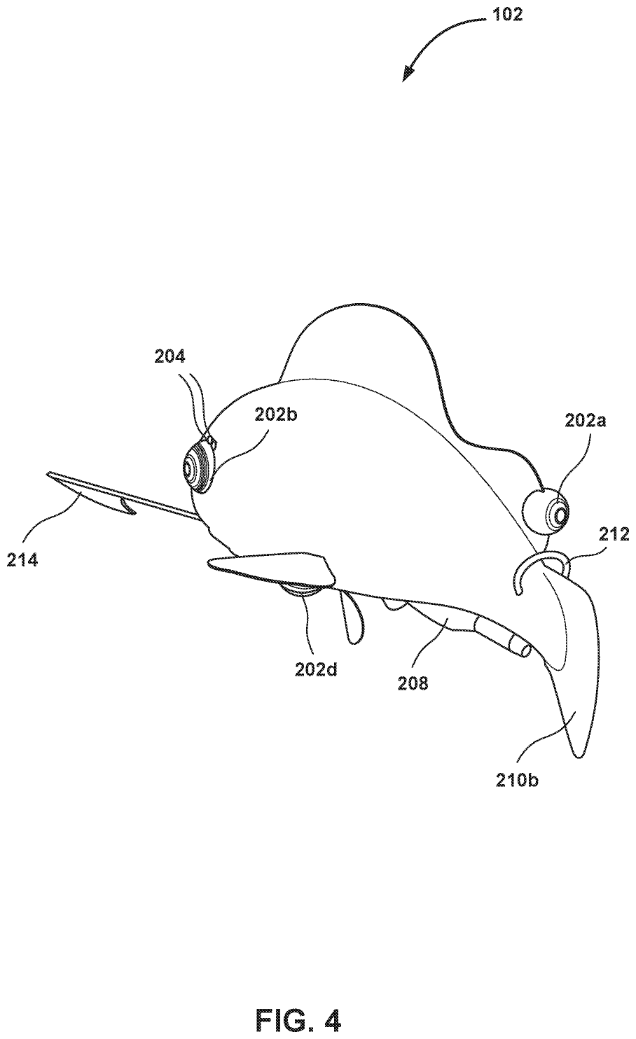

FIG. 3 is a diagram that illustrates a rear view of the fishing device 102, according to an exemplary embodiment of the present invention. FIG. 4 is a diagram that illustrates a rear-side view of the fishing device 102, according to an exemplary embodiment of the present invention. Operations of various components of the fishing device 102, shown in FIGS. 3 and 4, are same as described above in conjunction with FIG. 2.

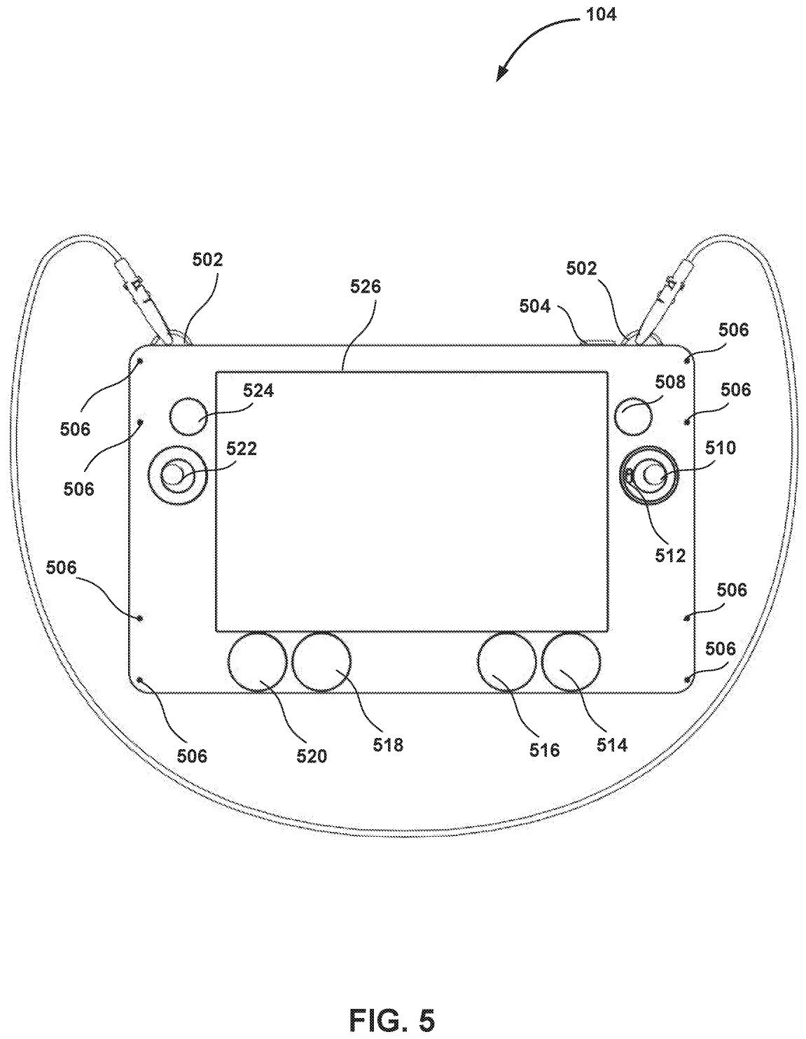

FIG. 5 illustrates a front view of the remote-controlled device 104, according to an exemplary embodiment of the present invention. The remote-controlled device 104 includes loops 502, a power button 504, and screw holes 506. The remote-controlled device 104 further includes a release button 508, a joystick 510, a switch 512, a toggle button 514, and a controller 516. The remote-controlled device 104 further includes a light button 518, a light button 520, a joystick 522, a return button 524, and a display 526.

The loops 502 are used for the lanyard. The power button 504 is used to turn ON the remote-controlled device 104. The power button 504 is a waterproof power button or switch device. The screw holes 506 are used for mounting, 4 on each opposing left and right side. The release button 508 is used for releasing the fishing arrow or spear 214 from the body of the fishing device 102 via its mouth. The joystick 510 is used to move the RC hunter (i.e., the fishing device 102) up and down. The switch 512 is used to turn ON-OFF fins of the fishing device 102. The switch 512 enables or disables fin control and cruise control. The switch 512 enables or disables speed control. The toggle button 514 is used to toggle between the camera devices and views. The controller 516 is used to control ON-OFF of the fishing device 102. The light button 518 is used to turn ON-OFF night vision types of lights. The light button 520 is used to turn ON-OFF standard vision types of lights. The joystick 522 is used to move the RC hunter (i.e., the fishing device 102) from one side to another side. The return button 524 is used to return or get back the fishing arrow or spear 214. The display 526 is used to display the images and videos captured by the camera devices 202a-202d.

In an embodiment, the operator uses the various options provided on the remote-controlled device 104 to control the fishing operations associated with the fishing device 102. For example, the operator uses the remote-controlled device 104 to turn ON the fishing device 102 under the water. The operator further uses the remote-controlled device 104 to navigate the fishing device 102 at different depths under the water. The operator further uses the remote-controlled device 104 to turn ON one or more camera devices of the fishing device 102 in order to view the underwater scenery (i.e., fishing environment) on a display screen of the remote-controlled device 104. The operator further uses the remote-controlled device 104 to control speed of the fishing device 102. The operator further uses the remote-controlled device 104 to control the maneuver or directions of the fishing device 102 under the water. The operator further uses the remote-controlled device 104 to control one or more types of light associated with the fishing device 102. Such lights may help the operator to capture good quality images and videos of the underwater scenery, which in turn helps the operator to locate an underwater fish and aim the targeted underwater fish with much ease. The operator may use the remote-controlled device 104 to view, locate, and target the underwater fish by using one or more fishing arrows or spears. The fishing arrows or spears are located inside a body of the fishing device 102 and can be released from the body of the fishing device 102 or returned back into the body of the fishing device 102 as per the operator's action and preferences. The fishing arrows or spears may be released through a mouth of the fishing device 102 to catch the underwater targeted fish. Based on successful or unsuccessful action, the operator may use the remote-controlled device 104 to get back the released fishing arrows or spears. Once the fish has been caught by the fishing arrows or spears, the operator may use the remote-controlled device 104 to navigate the fishing device 102 and bring it out of the water to get the caught fish.

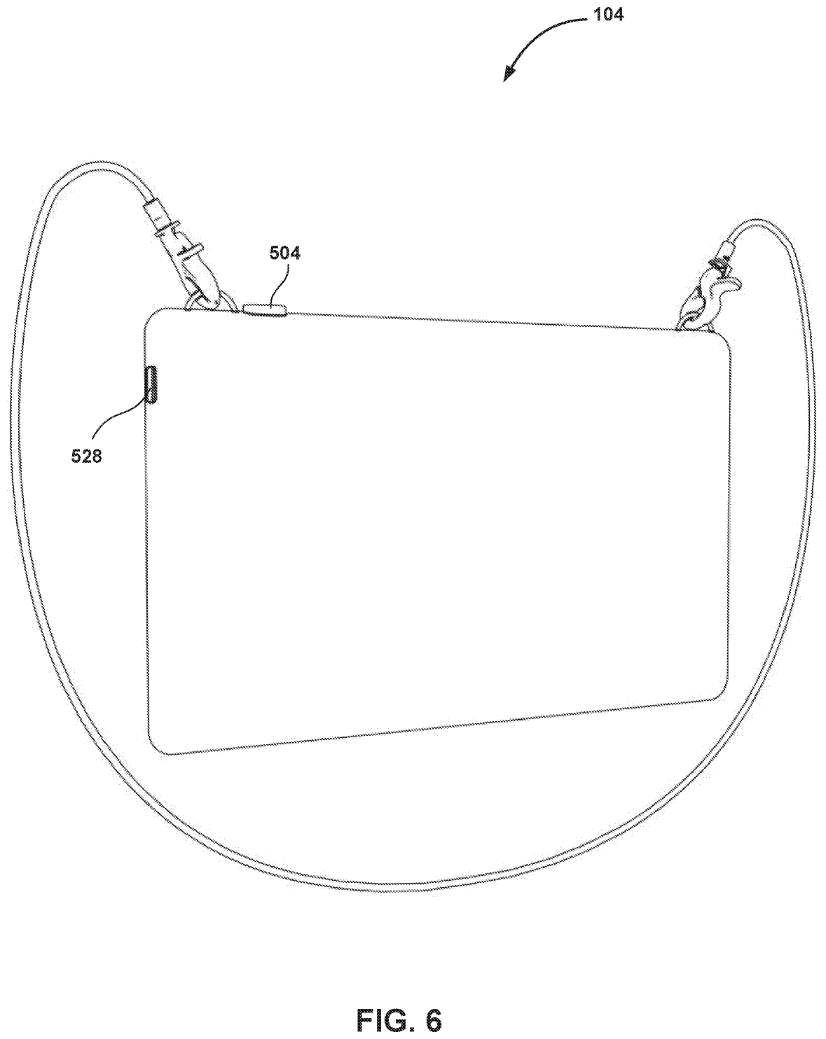

FIG. 6 illustrates a rear view of the remote-controlled device 104, according to an exemplary embodiment of the present invention. The rear view of the remote-controlled device 104 shows the power button 504 and a device charging port 528. The device charging port 528 is a waterproof USB charging port that is used for the charging the remote-controlled device 104.

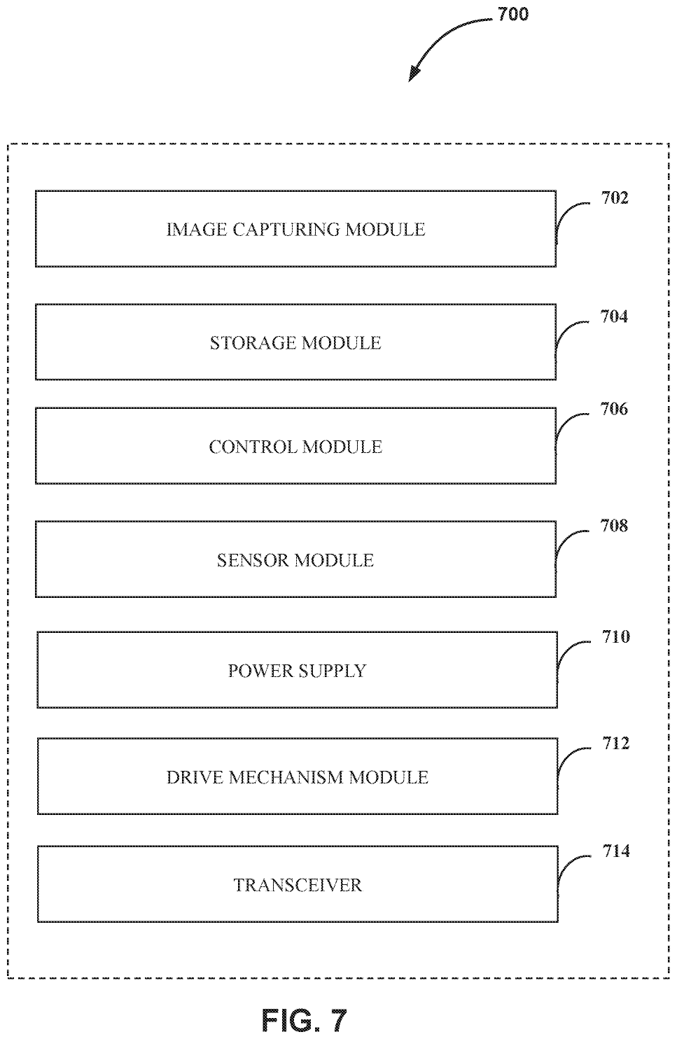

FIG. 7 is a block diagram that illustrates internal components of an electronic box 700 of the fishing device 102, according to an exemplary embodiment of the present invention. The electronic box 700 of the fishing device 102 includes an image capturing module 702, a storage module 704, a control module 706, a processor module 708, a power supply 710, a drive mechanism module 712, and a transceiver 714.

The image capturing module 702 may include the camera devices 202a-202d and may be configured to capture the underwater scenery including the one or more fishes. Further, the image capturing module 702 may be configured to communicate the captured images and videos of the underwater scenery to the remote-controlled device 104 via the communication network 106.

The storage module 704 is configured to store data related to the captured images and videos of the underwater scenery. Further, the storage module 704 is configured to store code, instructions, programs, or algorithms that are executed by various components of the fishing device 102 to perform the one or more fishing operations. In an embodiment, the storage module 704 is a multi-tier storage system. In another embodiment, the storage module 704 stores the information, code, instructions, programs, or algorithms in an encrypted format. In yet another embodiment, the storage module 704 stores the information in an indexed format. The storage module 704 facilitates storage, retrieval, modification, and deletion of data in conjunction with various data processing operations. Storage module information may be retrieved through queries using keywords and sorting commands, in order to rapidly search, rearrange, group, and select the field.

In one embodiment, the storage module 704 is secure web servers and Hypertext Transport Protocol Secure (HTTPS) capable of supporting Transport Layer Security (TLS. Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The control module 706 may comprise analog circuits or a digital microprocessor for controlling the various components in the fishing device 102. The control module 706 may be a microcontroller or analog circuits, discreet logic, or mechanical or other structures that make use of digital and/or analog input and output to perform the required tasks associated with the fishing operations. The microprocessor is preferred due to its low cost and re-programmability. The control module 706 may include a timer, several I/O functions, and the like as required to simultaneously detect, measure, and control several signal sources and destinations. Instructions and data transmitted to the fishing device 102 from the remote-controlled device 104 are received in the data transceiver 714 which passes them to the control module 706. When the device is operating in the autonomous mode, the storage module 704 (i.e., a program memory) provides the application instructions to the control module 706.

The sensor module 708 may include one or more sensors and may include suitable logic, circuitry, interfaces, and/or code, executable by the circuitry, that may be configured to perform one or more operations. For example, the sensor module 708 of the fishing device 102 may include an optional temperature sensor. Fish are known to seek out water of a particular temperature. The fishing device 102 may be programmed to descend until the water temperature equals a predefined temperature. The fishing device 102 may then climb and descend as necessary to follow a path that maintains a constant temperature. The fishing device 102 communicates with the remote-controlled device 104 via the communications network 106. As noted above, this link may be hard wired via the tether, or may utilize sonic, electromagnetic, or other suitable communications technologies. The control module 706 in the fishing device 102 interrogate the optional temperature sensor and may then store the measurement in memory for later use. Alternatively, the control module 706 may adjust the course or depth of the fishing device 102 to maintain a predefined temperature profile. If the optional temperature sensor is present, but the water temperature feature is not activated, the temperature measurements may be discarded. The sensor module 708 of the fishing device 102 may include various sensors such as radar and sonar. All such data can be utilized to provide steering instructions to the fishing device 102.

The power supply 710 (such as one or more batteries) supplies electrical power to all components of the fishing device 102. The power supply 710 is the source of power for all the components of the fishing device 102 and is preferably rechargeable batteries. Power may be distributed to the components through a fused connection and voltage regulators as required (not shown).

The drive mechanism module 712 may be a small DC electric motor with a propeller mounted on the drive shaft thereof. When the fishing device 102 is being towed, a speed indication may be passed from the remote-controlled device 104 to the fishing device 102. In an embodiment, the device's speed may be determined by reading the RPMs from the drive mechanism 712 or from a small water wheel with a magnetic pickup to determine RPMs. The speed of the fishing device 102 through the water is used as an input to the dive plane mechanism and the rudder mechanism to determine the amount of control surface deflection required to achieve a desired maneuver. At slower speeds, greater deflections are required to achieve the same results.

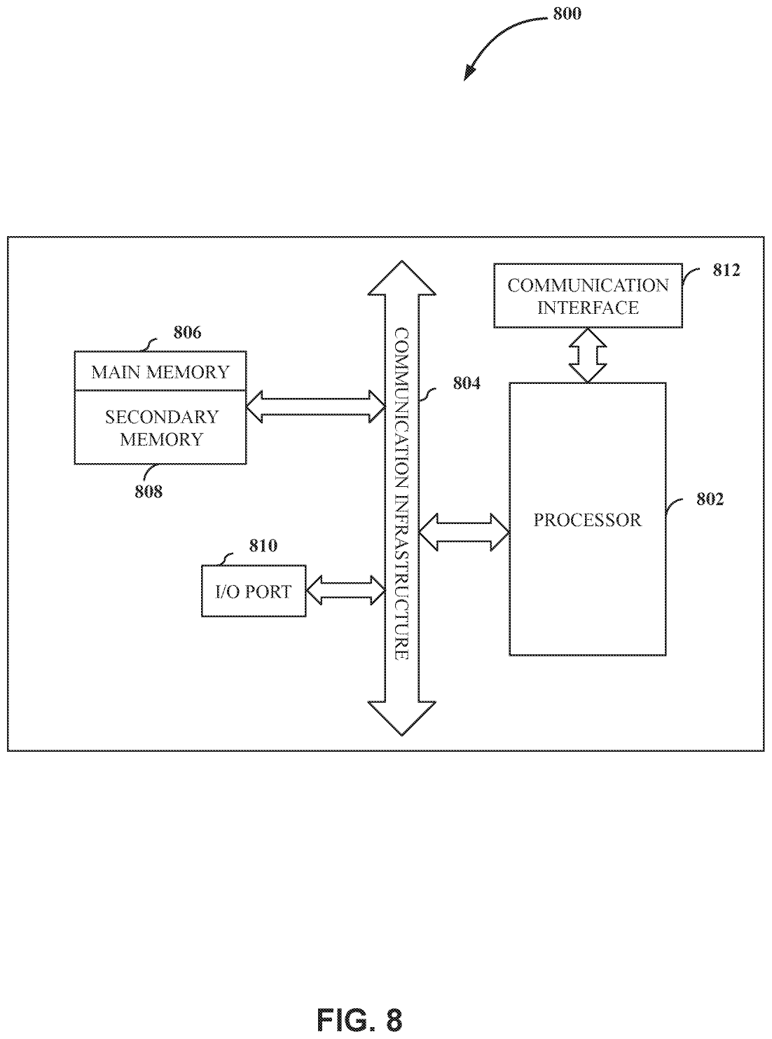

FIG. 8 is a diagram that illustrates a system architecture of a computer system 800 for facilitating under water fishing, according to an exemplary embodiment of the present invention. An embodiment of the disclosure, or portions thereof, may be implemented as computer readable code on the computer system 800. In one example, various components (such as the fishing device 102 or the remote-controlled device 104) of FIG. 1 may be implemented in the computer system 800 using hardware, software, firmware, non-transitory computer readable media having instructions stored thereon, or a combination thereof and may be implemented in one or more computer systems or other processing systems. Hardware, software, or any combination thereof may embody modules and components used to implement the fishing methods as described above.

The computer system 800 may include a processor 802 that may be a special purpose or a general-purpose processing device. The processor 802 may be a single processor, multiple processors, or combinations thereof. The processor 802 may have one or more processor “cores.” Further, the processor 802 may be coupled to a communication infrastructure 804, such as a bus, a bridge, a message queue, the communication network, multi-core message-passing scheme, and the like. The computer system 800 may further include a main memory 806 and a secondary memory 808. Examples of the main memory 806 may include RAM, ROM, and the like. The secondary memory 808 may include a hard disk drive or a removable storage drive (not shown), such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer readable recording media.

The computer system 800 may further include an I/O port 810 and a communication interface 812. The I/O port 810 may include various input and output devices that are configured to communicate with the processor 802. Examples of the input devices may include a keyboard, a mouse, a joystick, a touchscreen, a microphone, and the like. Examples of the output devices may include a display screen, a speaker, headphones, and the like. The communication interface 812 may be configured to allow data to be transferred between the computer system 800 and various devices that are communicatively coupled to the computer system 800. Examples of the communication interface 812 may include a modem, a network interface, i.e., an Ethernet card, a communications port, and the like. Data transferred via the communication interface 812 may be signals, such as electronic, electromagnetic, optical, or other signals as will be apparent to a person of ordinary skill in the art. The signals may travel via a communications channel, such as the communication network, which may be configured to transmit the signals to the various devices that are communicatively coupled to the computer system 800. Examples of the communication channel may include a wired, wireless, and/or optical medium such as cable, fiber optics, a phone line, a cellular phone link, a radio frequency link, and the like. The main memory 806 and the secondary memory 808 may refer to non-transitory computer readable mediums that may provide data that enables the computer system 800 to implement the fishing methods.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however some of the operations may in fact be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems and apparatus for facilitating fishing operations by using a remote-controlled device. While various exemplary embodiments of the disclosed system and apparatus have been described above, it should be understood that they have been presented for purposes of example only, and not limitations. It is not exhaustive and does not limit the disclosure to the precise form disclosed. Modifications and variations are possible in light of the above teachings or may be acquired from practicing of the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

Although particular embodiments of the invention have been described in detail for purposes of illustration, various modifications and enhancements may be made without departing from the spirit and scope of the invention. The scope of the invention is accordingly defined by the following claims.

I claim:

1. A fishing system for facilitating fishing, comprising:
a fishing device; and
a remote-controlled device,
wherein the fishing device comprises at least four camera devices that are configured to capture one or more images of an underwater scenery when the fishing device is submerged in a water body for fishing,
wherein the fishing device communicates the one or more images to the remote-controlled device via a communication network, and
wherein an operator uses the remote-controlled device to release a fishing arrow or spear of the fishing device to catch an underwater fish based on the one or more images displayed on a display of the remote-controlled device.

2. The fishing system of claim 1, wherein the camera devices are installed as eyes of the fishing device that are controlled by the operator using the remote-controlled device via the communication network.

3. The fishing system of claim 1, wherein the fishing arrow or spear is located inside a body of the fishing device and is released via a mouth of the fishing device.

4. The fishing system of claim 3, wherein the release of the fishing arrow or spear is controlled by the operator using the remote-controlled device via the communication network.

5. The fishing system of claim 1, wherein the fishing device further comprises at least a standard light and a night vision light over each camera device.

6. The fishing system of claim 1, wherein the fishing device further comprises a retractor loop that is located before a tail of the fishing device, and wherein a fishing line is attached to the retractor loop and leads to a fishing pole.

7. The fishing system of claim 1, wherein the fishing device further comprises side fins and a tail fin for facilitating movement of the fishing device, wherein the side fins move up and down and the tail fin moves side to side.

8. The fishing system of claim 1, wherein the fishing device further comprises an inboard jet engine that is configured to propel the fishing device under water.

9. The fishing system of claim 1, wherein the fishing device further comprises a waterproof USB charging port that can be used for charging one or more batteries of the fishing device.

10. The fishing system of claim 1, wherein the remote-controlled device further comprises a waterproof power button that is used by the operator to turn ON the remote-controlled device.

11. The fishing system of claim 1, wherein the remote-controlled device further comprises a button to release the fishing arrow or spear from the body of the fishing device.

12. The fishing system of claim 11, wherein the remote-controlled device further comprises a button to return the fishing arrow or spear into the body of the fishing device.

13. The fishing system of claim 1, wherein the remote-controlled device further comprises a joystick to move the fishing device up and down.

14. The fishing system of claim 13, wherein the remote-controlled device further comprises a joystick to move the fishing device from one side to another side.

15. The fishing system of claim 1, wherein the remote-controlled device further comprises a toggle button to toggle between the camera device and views.

16. The fishing system of claim 1, wherein the remote-controlled device further comprises a light button that is used by the operator to turn ON night vision light of the fishing device.

17. The fishing system of claim 16, wherein the remote-controlled device further comprises a light button that is used by the operator to turn ON standard light of the fishing device.

18. The fishing system of claim 1, wherein the remote-controlled device further comprises a waterproof USB charging port that is used for charging the remote-controlled device.
